(19) United States
(12) Patent Application Publication
(10) Pub. No.: US 2024/0027869 A1
(43) Pub. Date: Jan. 25, 2024

(54) OUTPUT/WAVELENGTH DIVISION MULTIPLEXING LIDAR ARCHITECTURE

(71) Applicant: Intel Corporation, Santa Clara, CA (US)

(72) Inventors: Jonathan Doylend, Savannah, MO (US); Amit Mizrahi, San Jose, CA (US); Faraz Monifi, Mountain View, CA (US); Saeed Fathololoumi, Los Gatos, CA (US)

(73) Assignee: Intel Corporation, Santa Clara, CA (US)

(21) Appl. No.: 18/374,558

(22) Filed: Sep. 28, 2023

(51) Int. Cl. G02F 1/313; G02F 1/29; G01S 7/481

(52) U.S. Cl. CPC G02F 1/313; G02F 1/292; G01S 7/4817

(57) ABSTRACT

A multi-wavelength transmitter suitable for use in LiDAR applications where an array of output beams comprising a plurality of wavelengths is spatially modulated with low amplification requirements. The optical transmitter comprises one or more light sources, such as a plurality of laser emitters operable at different wavelengths. The light source(s) are coupled, for example through one or more planar waveguides, to an optical switch network comprising one or more switches. The switch network is to route, in a time divided manner, source beams to individual ones of a plurality of switch output ports thereby modulating the wavelength of a beam exiting each of the output ports. A plurality of output couplers, for example comprising edge coupled spot size convertors, are coupled to separate ones of the switch output ports, for example through one or more planar waveguides and/or one or more beam splitters.

### BACKGROUND

LIDAR is an acronym of “light detection and ranging” or “laser imaging, detection, and ranging” where a distance to a far field object or a surface targeted by a light emission is determined through measuring the time for reflected light to return to a receiver. LIDAR has seen extensive use in autonomous robotics and vehicles, mobile devices, and spatial mapping. In LIDAR beam steering is typically employed, which can be mechanical but now often relies on silicon photonics that provide a path for low-cost chip-scale LIDAR systems. LIDAR system architectures sometimes employ a multi-wavelength approach in which the light emitted, for example from a photonic integrated circuit (PIC), is cycled through several wavelengths to scan emission angles.

LIDAR faces the challenge of covering a wide field of view with high spatial resolution, such that it is beneficial to increase a number N of final outputs. Light may be routed to an output comprising a dispersive element, such as an optical grating, that directs beams to different locations in the far field. In this approach, a single initial launch wavelength is selected, amplified and split until it is emitted from a final array of N outputs. Successive wavelengths may be launched from the output into the dispersive element. As each wavelength is selected, a different array of spots are targeted in the far field. This approach enables an array of N emitted beams to be launched from a transmitter in a direction selected by the wavelength used. However, as the number N increases, successive amplification stages become necessary to reach a sufficient emission power without excessively high laser power. For example, for each 1×4 splitter, at least 6 dB of amplification may be needed to maintain adequate power in each channel. For a single wavelength in use at any given moment split and routed to N output couplers, a total gain of N is required to maintain output power within each channel. The same gain is then required for the second wavelength and each successive wavelength used to interrogate a total of N×M spots, where M is the number of wavelengths or channels.

Optical transmission techniques and architectures capable of generating a given far field spot count with lower power requirements, smaller transmitter form factors and/or lower cost are commercially advantageous.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIGS. 1A, 1B and 1C are schematics of a LIDAR transmitter (Tx) architecture in three different time divided states, in accordance with some embodiments;

FIGS. 2A and 2B are schematics of the LIDAR Tx architecture illustrated in FIG. 1A-1C further illustrating variations in beam splitter architecture, in accordance with some embodiments;

FIG. 3 is a schematic of the LIDAR Tx architecture illustrated in FIG. 2B in which a switch network is implemented with a tunable array waveguide grating (AWG), in accordance with some embodiments;

FIG. 4 is a planar AWG that may implement the switch network of the LIDAR architecture illustrated in FIG. 3, in accordance with some embodiments;

FIG. 5 is a schematic of a LIDAR Tx architecture in which the switch network is implemented with a fixed multiplexer and tunable drop filter, in accordance with some embodiments;

FIG. 6 is a schematic of a LIDAR Tx architecture in which the switch network is implemented with tunable ring waveguide filters in accordance with some embodiments with eight laser sources and sixteen output couplers, in accordance with some embodiments;

FIG. 7 is schematic of a LIDAR system that includes one or more of the LIDAR Tx architectures of FIG. 1A-FIG. 6, in accordance with some embodiments;

FIG. 8 is a functional block diagram of an electronic computing device, that may implement one or more of the components of the LIDAR system illustrated in FIG. 7, in accordance with some embodiments.

### DETAILED DESCRIPTION

Embodiments are described with reference to the enclosed figures. While specific configurations and arrangements are depicted and discussed in detail, this is done for illustrative purposes only. Persons skilled in the relevant art will recognize that other configurations and arrangements are possible without departing from the spirit and scope of the description. It will be apparent to those skilled in the relevant art that techniques and/or arrangements described herein may be employed in a variety of other systems and applications other than what is described in detail herein.

Reference is made in the following detailed description to the accompanying drawings, which form a part hereof and illustrate exemplary embodiments. Further, it is understood that other embodiments may be utilized and structural and/or logical changes may be made without departing from the scope of claimed subject matter. It should also be noted that directions and references, for example, up, down, top, bottom, and so on, may be used merely to facilitate the description of features in the drawings. Therefore, the following detailed description is not to be taken in a limiting sense and the scope of claimed subject matter is defined solely by the appended claims and their equivalents.

In the following description, numerous details are set forth. However, it will be apparent to one skilled in the art, that embodiments may be practiced without these specific details. In some instances, well-known methods and devices are shown in block diagram form, rather than in detail, to avoid obscuring the embodiments. Reference throughout this specification to “an embodiment” or “one embodiment” or “some embodiments” means that a particular feature, structure, function, or characteristic described in connection with the embodiment is included in at least one embodiment. Thus, the appearances of the phrase “in an embodiment” or “in one embodiment” or “some embodiments” in various places throughout this specification are not necessarily referring to the same embodiment. Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items.

The terms “coupled” and “connected,” along with their derivatives, may be used herein to describe functional or structural relationships between components. These terms are not intended as synonyms for each other. Rather, in particular embodiments, “connected” may be used to indicate that two or more elements are in direct physical, optical, or electrical contact with each other. “Coupled” may be used to indicated that two or more elements are in either direct or indirect (with other intervening elements between them) physical or electrical contact with each other, and/or that the two or more elements co-operate or interact with each other (e.g., as in a cause-and-effect relationship).

The terms “over,” “under,” “between,” and “on” as used herein refer to a relative position of one component or material with respect to other components or materials where such physical relationships are noteworthy. For example, in the context of materials, one material or layer over or under another may be directly in contact or may have one or more intervening materials or layers. Moreover, one material between two materials or layers may be directly in contact with the two materials/layers or may have one or more intervening materials/layers. In contrast, a first material or layer “on” a second material or layer is in direct contact with that second material/layer. Similar distinctions are to be made in the context of component assemblies.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C.

As previously noted, a LIDAR system may advantageously comprise a transmitter (Tx) or “emitter” with a multi-wavelength (multi-channel) source. As described further below, a LIDAR Tx may comprise a switch network to modulate different wavelengths across various ones of a plurality of output couplers, which may couple the beams to any downstream optical elements that are further operable to illuminate a plurality of far field spots. In this manner, all output couplers emit different input wavelengths at different instants in time, thereby spatially modulating an array of output beams to get a full interrogation of angles within a LIDAR field of view. At each instant in time during operation, the fraction of the output couplers emitting a given input wavelength is reduced to a ratio of the total number of output couplers divided by the total number of input wavelengths. This reduction in the number of far field spots illuminated by any given wavelength reduces optical beam amplification requirements, for example relative to an architecture where all output couplers emit a single input wavelength at any instant in time. In accordance with embodiments herein, the switch network may modulate to which of the output couplers each of the source wavelengths is routed at any instant in time. The switch network may implement any desired time division algorithm to alternate which source wavelength is emitted by each of the output couplers.

In accordance with exemplary embodiments, LIDAR Tx architectures are advantageously implemented with one or more photonic integrated circuits (PICs), and more specifically with one or more silicon photonic SiPh chips (that may also include III-V semiconductor material). Although many examples herein are therefore further described in the context of SiPh implementations, the exemplary LIDAR Tx architectures may instead be implemented in alternative technologies without departing from the principles disclosed herein.

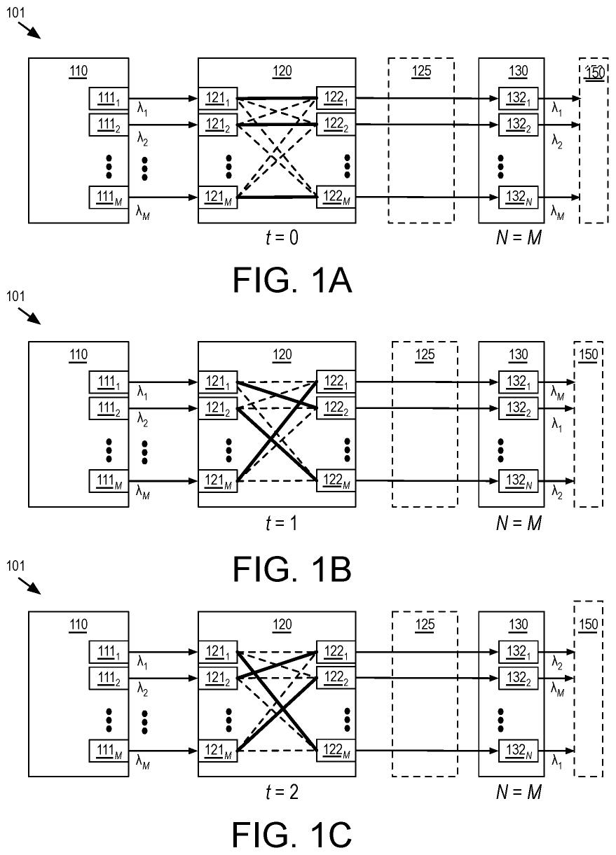

FIGS. 1A, 1B and 1C are schematics of a LIDAR transmitter (Tx) architecture 101 in three different time divided states, in accordance with some embodiments. FIG. 1A illustrates a first state of LIDAR Tx architecture 101 at a first exemplary time instant (e.g., t=0, or t₀). FIG. 1B illustrates a second state of LIDAR Tx architecture 101 at a second exemplary time instant (e.g., t=1, or t₁). FIG. 1C illustrates a third state of LIDAR Tx architecture 101 at a third exemplary time instant (e.g., t=2, or t₂). Three states are illustrated for clarity of discussion. However, in practice, LIDAR transmitter architecture 101 may have any number of states as a function of parameters of the specific implementation. For example, in some embodiments further described below, a switch network may have as many different states as there are different wavelengths of light coupled into the switch network.

Referring first to FIG. 1A, LIDAR Tx architecture 101 comprises a multi-wavelength or multi-channel optical beam source 110 optically coupled to a switch network 120. Switch network 120 is optically coupled to output coupler array 130 through any number of optical elements 125, drawn in dashed line to emphasize intervening optical elements 125 are optional. Output coupler array 130 outputs to a downstream optical element(s) 150, which in exemplary embodiments includes a dispersive element that spatially separates optical beams exiting output coupler array 130 to propagate in free space and illuminate a set of far field points. In exemplary embodiments, optical element(s) 150 comprise a diffractive grating having parameters suitable for the wavelength range of multi-channel source 110. Optical element(s) 150 may further comprise one or more lenses suitable for spot size conversion, etc.

One or more of source 110, switch network 120, optical elements 125, and output coupler array 130 may be implemented in a SiPh chip. In some embodiments, switch network 120 and output coupler array 130, as well as any intervening optical elements 125, are implemented in a single (e.g., first) SiPh chip. In exemplary embodiments, multi-wavelength source 110 is implemented in the same SiPh chip as switch network 120. However, in some multi-chip implementations, switch network 120, output coupler array 130 and optical elements 125 are implemented in a first PIC while source 110 is implemented in a second PIC chip.

In some embodiments, multi-wavelength source 110 comprises a plural number M of laser emitters 111₁-111_{M} operable at different channel wavelengths. The number of wavelengths M may vary with implementation (e.g., ranging from 2 to 64, or more). In exemplary embodiments, each laser emitter 111₁-111_{M} is operable at a center channel wavelength λ1-λM unique among emitters 111₁-111_{M}. In some exemplary embodiments, the channel wavelengths λ1-λM span at least a portion of the O-band (i.e., 1260-1360 nm) of the electromagnetic spectrum. In some other embodiments, the channel wavelengths λ₁-λ_{M} span at least a portion of the C-band (i.e., 1530-1565 nm) of the electromagnetic spectrum. Wavelengths λ₁-λ_{M} may span alternative ranges, particularly where architecture 101 is implemented in other than a silicon PIC and wavelengths may be shorter than those suitable for silicon. Each laser emitter 111₁-111_{M} is advantageously a laser diode, such as a distributed-feedback (DFB) laser operable in a continuous-wave (CW) emission mode, or an external cavity laser. In exemplary embodiments, each laser emitter 111₁-111_{M} emits at a power of around 10 dbm, or more. In further embodiments, each laser emitter 111₁-111_{M} is frequency modulated (FM), or chirped. A frequency modulated carrier wave (FMCW) may be modulated, for example, such that frequency as a function of time defines an approximately triangular waveform. The frequency range of one modulation period may vary with one exemplary range being 1-5 GHz. Other techniques for emission modulations may also be practiced in alternative embodiments. For example, emission may be direct modulated through current injection or a Mach-Zehnder (MZ) modulator.

As shown, each of emitters 111₁-111_{M} is optically coupled to a corresponding channel input port 121₁-121_{M} of switch network 120. Although M input ports are illustrated for clarity of discussion, switch network 120 may have as few as one input port. In exemplary SiPh IC embodiments, emitters 111₁-111_{M} are optically coupled to input ports 121₁-121_{M} through on-chip planar optical waveguides. Such optical waveguides may be channel specific for embodiments with input ports 121₁-121_{M} or multi-channel if switch network 120 comprises fewer than M input ports. Switch network 120 may comprise one or more single channel and/or multi-channeled optical switches arranged in any manner suitable for coupling each of the switch input ports (e.g., 121₁-121_{M}) to each of M optical switch output ports 122. In some exemplary embodiments, switch network 120 implements an M×M non-blocking optical matrix switch whereby each one of input ports 121₁-121_{M} can be selectably and/or switchably routed or coupled to each of output ports 122₁-122_{M}.

In FIG. 1A, solid lines between input ports 121₁-121_{M} and output ports 122₁-122_{M} represent an active optical path at time instant t=0. Dashed between input ports 121₁-121_{M} and output ports 122₁-122_{M} represent alternative optical paths that are inactive at time instant t=0. Hence, at time t=0, switch input port 121₁ is optically coupled to switch output port 122₁. Concurrently (i.e., at t=0), switch input port 121₂ is optically coupled to switch output port 122₂ and switch input port 121_{M} is optically coupled to switch output port 122_{M}.

Switch output ports 122₁-122_{M} are optically coupled, optionally through one or more optical elements 125, to one or more corresponding output couplers 132 of array 130. As illustrated, output coupler array 130 comprises a plural number N of output couplers 132₁-132_{N}. The number N may vary with implementation (e.g., ranging from 2 to 64, or more). For the embodiment illustrated in FIG. 1A, N is equal to M. However, as further described below, for embodiments where the intervening optical elements 125 comprise one or more optical beam splitters, N and M are unequal with N being an integer number larger than M according to any beam splitting ratio that desired to reach any number of emissions suitable for a particular LIDAR application.

In exemplary SiPh IC embodiments, output ports 122₁-122_{M} are optically coupled to output couplers 132 through one or more on-chip planar optical waveguides. For such embodiments, each output coupler 132₁-132_{N} advantageously comprises an edge coupler (EC) but may alternatively comprise a grating coupler (GC), for example. Output couplers 132 may further comprise a spot-size convertor, such as any known to be suitable for expanding an optical mode from dimensions of a single mode planar waveguide having certain refractive index to a mode size of any off-chip optical element 150.

With switch network in a first state at a first time instant (t=0), an optical beam of wavelength λ₁ is routed to output coupler 132₁, for example where it is emitted off-chip. A second optical beam of wavelength λ₂ is similarly emitted off-chip by output coupler 132₂ and an Mth optical beam of wavelength λ_{M} is similarly emitted off-chip by output coupler 132_{M}. During operation, switch network 120 is to route optical beams from emitters 111₁-111_{M}, to alternating output ports 122₁-122_{M} in a time divided manner, thereby modulating a wavelength of the beam exiting from each of the output ports 122₁-122_{M}. Output couplers 132₁-132_{N} similarly emit a beam with a modulated center wavelength. Accordingly, over time each of wavelengths λ₁-λ_{M} are emitted from each of output couplers 132₁-132_{N}. FIG. 1B, for example, depicts switch network 120 in a second state at another time instant (t=2) where the optical beam of wavelength λ₁ is coupled to switch output port 122₂. Accordingly, this beam is now emitted from output coupler 132₂ while a beam of wavelength λ₂ is emitted by output coupler 132_{N} and another of wavelength km is emitted by output coupler 132₁. In a third state illustrated in FIG. 1C, switch network 120 during another time instant (t=3) couples the optical beam of wavelength λ₁ to switch output port 122_{M} and output coupler 132_{N} while the optical beam of wavelength λ₂ is coupled to switch output port 122₁ and output coupler 132₁. The optical beam of wavelength km is concurrently coupled to switch output port 122₂ and output coupler 132₂. Although only three states are illustrated by FIG. 1A-1C, switch network 120 may similarly transition between M different states with each of the M states routing M wavelengths through N different output couplers.

Switch network state transitions may be according to any scheduling algorithm, such as a round-robin or other circular queue. In some exemplary embodiments, the duration that each of wavelengths λ₁-λ_{M} are emitted from each of output couplers 132₁-132_{N} is time averaged to be approximately equal across all wavelengths.

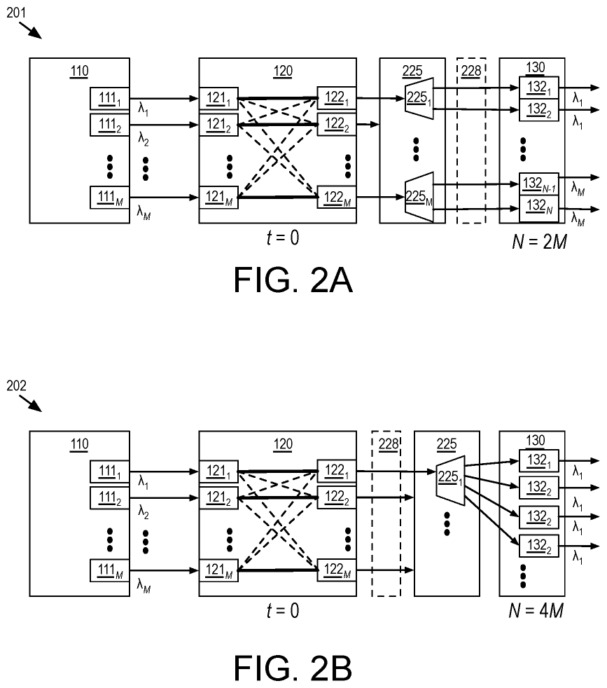

In some embodiments, optical elements 125 within the beam paths between switch network 125 and output coupler array 130 comprise a plurality of optical beam splitters. FIGS. 2A and 2B are schematics of the LIDAR Tx architectures 201A and 201B, which further include an optical splitter array 225. In FIG. 2A, LIDAR Tx architecture 201A, optical splitter array 225 comprises one splitter corresponding to each switch output port. Hence optical spitter array 225 comprises M channel splitters 225₁-225_{M}, each with one input port coupled to a corresponding one of switch output ports 122₁-122_{M}. Depending on the split ratio, optical splitters 225₁-225_{M} may each have any number of output ports for a total of N output ports matching the N output couplers of output coupler array 130. In architecture 201A, each of splitters 225₁-225_{M} has a 1:2 split ratio such that N=2M. In FIG. 2B, LIDAR Tx architecture 201B comprises splitters with an alternative 1:4 split ratio such that N=4M. The split ratio may accordingly vary with implementation, for example from 1:64, or more.

Optical spitters 225₁-225_{M} may have any architecture suitable for the application. In exemplary embodiments where switch output ports 122₁-122_{M} are coupled to spitters 225₁-225_{M} by a plurality of planar optical waveguides (e.g., in a SiPh implementation), each of spitters 225₁-225_{M} comprise a planar light circuit (PLC) splitter. PLC splitters may be single mode or multimode passive devices as embodiments are not limited in this respect. In some SiPh embodiments, output ports of spitters 225₁-225_{M} are coupled to output couplers 132₁-132_{N} through N planar single-mode waveguides each having for example, a transverse dimension of 1-2 μm.

As further illustrated in FIG. 2A-2B, one or more optical elements 228 may be on either side of optical splitter array 225. In some embodiments, optical elements 228 comprise one or more optical gain stages. The number of optical gain stages may vary (e.g., from none to four, or more) as a function of the splitting ratio of optical splitter array 225, and/or the output power of multi-channel source 110, and/or the far field parameters associated with a particular LIDAR application. Each optical gain stage may be of any suitable architecture. In some exemplary embodiments, a single gain stage comprises a semiconductor optical amplifier (SOA) comprising any suitable gain medium and/or pumping architecture. SiPh embodiments may implement an SOA, for example, through heterogeneous integration with one or more III/V materials.

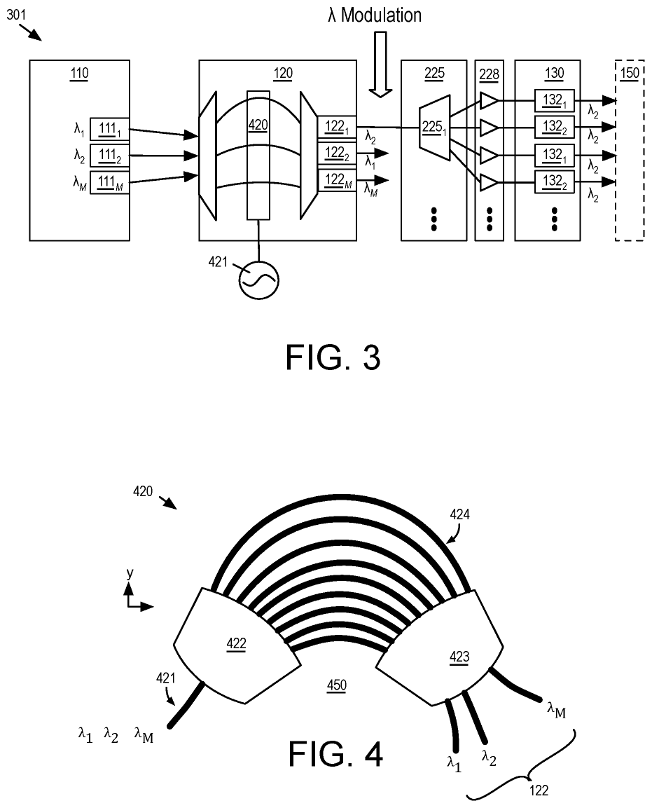

Switch network 120 may be implemented with any optical switch(es), such as MEMs mirror arrays and solid state optical switches. In exemplary SiPh embodiments, switch network 120 comprises one or more of an echelle grating, array waveguide grating, ring filter, or any other tunable optical multiplexer/demultiplexer. FIG. 3 is a schematic of a LIDAR Tx architecture 301 in which switch network 120 is implemented with a tunable array waveguide grating (AWG) 420. AWG 420 comprises an input coupler optically coupled to a plurality of grating waveguides of varying lengths that all converge at an output coupler. The varying waveguide path lengths result in wavelength dependent constructive interference at switch output ports 122₁-122_{M}. For this switch architecture, switch network 120 is coupled to a phase tuner 421 that is to control time modulation of the wavelength exiting each of switch output ports 122₁-122_{M}.

FIG. 4 is a plan view of a planar implementation of AWG 420, in accordance with some SiPh embodiments. As shown, grating waveguides 424 of different lengths are between input coupler 422 and output coupler 423. One or more input waveguides 421 may enter input coupler 422. Optical beams of channels λ₁-λ_{M} converge at output coupler 423 and exit as separate channels across output port array 122.

Phase tuner 421 (FIG. 3) may be coupled to AWG 420 to modulate one or more parameters of AWG 420, for example through one or more of electro-refraction, electro-absorption, or thermo-optic effects. In some exemplary SiPh embodiments, tuner 421 comprises a thermo-optic phase tuner. In still other embodiments, AWG 420 includes one or more physically displaceable waveguides. For example, one or more input waveguides, output waveguides, or grating waveguides of AWG 420 may be displaceable relative to other optical elements. In some embodiments illustrated by FIG. 4, input waveguide(s) 421 may be displaceable relative to AWG input coupler 422. Input waveguide(s) 421 may be at least partially released from a substrate 450 so it is physically displaceable within the plane of input coupler 422, for example, by a MEMs driver (not depicted). The MEMs driver may have any architecture, such as, but not limited to, an electrostatic comb drive.

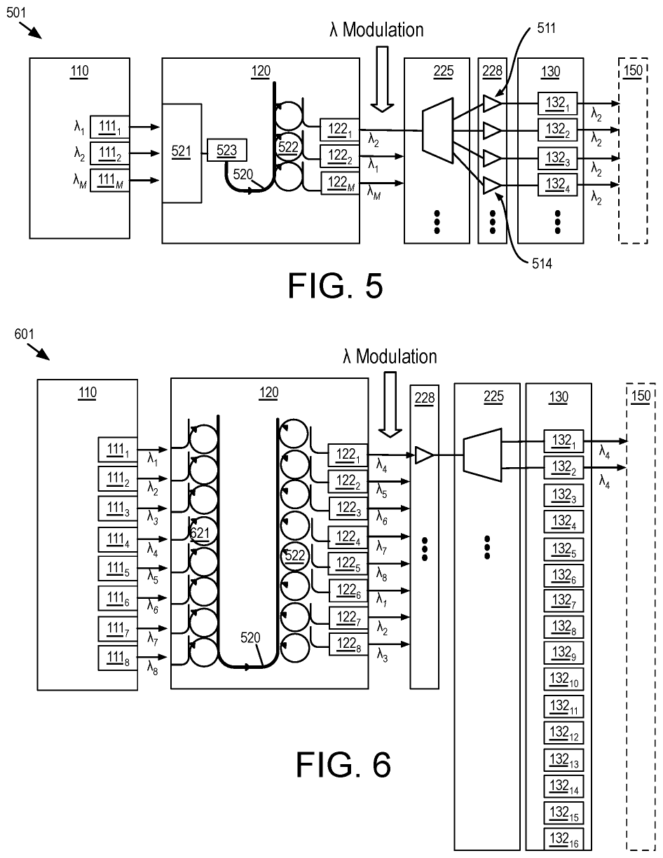

FIG. 5 is a schematic of a LIDAR Tx architecture 501 where switch network 120 comprises a fixed multiplexer 521 and a tunable drop filter 522, in accordance with some embodiments. As shown, multiplexer 521 is optically coupled to M-channeled source 110. Multiplexer 521 may comprise an M:1 AWG, which need not be tunable in this example. Multiplexer 521 may alternatively comprise an echelle grating. The output port of multiplexer 521 is coupled to a multi-channel (i.e., bus) waveguide 520, for example through an optical isolator 523. Bus waveguide 520 is further coupled to a tunable drop filter 522. In the illustrated example, drop filter 522 comprises a plurality of resonant add/drop ring waveguide filters, each coupled to one of switch output ports 122₁-122_{M}. Drop filter 522 may be tunable to implement the channel (λ) modulation described above, for example, through one or more of electro-refraction, electro-absorption, or thermo-optic effects. As further illustrated by FIG. 5, splitter array 225 comprises M 1:4 optical splitters with each splitter output port optically coupled to one of four amplifiers (e.g., SOAs) 511-514. Amplifiers 511-514 output to individual output couplers 132₁-132₄.

FIG. 6 is a schematic of the LIDAR Tx architecture 601 further illustrating some embodiments where multi-channel source 110 comprises eight laser emitters 111₁-111₈, and output coupler array 130 comprises sixteen output couplers 132₁-132₁₆. FIG. 6 further illustrates embodiments where optical elements 228 comprise eight optical amplifiers between switch network 120 and splitter array 225. In this example, splitter array 225 comprises eight 1:2 splitters. Switch network 120 comprises an eight-ring multiplexer, which couples emitters 111₁-111₈ to bus waveguide 520. Eight tunable drop ring waveguide filters 522 further couple bus waveguide 520 to each of each eight switch output ports 122₁-122₈.

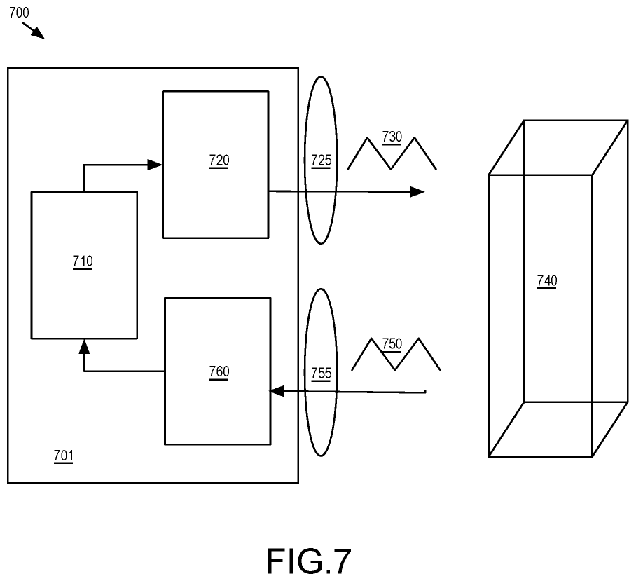

LIDAR Tx architectures in accordance with embodiments herein may be paired with any suitable receiver Rx architecture for integration into a LIDAR system having one or more of lower power requirements, greater spatial resolution. FIG. 7 is schematic of a LIDAR system 700 that includes one or more of the LIDAR Tx architectures 101-601, in accordance with some embodiments. LIDAR system 700 may be integrated into any application platform. In some examples, LIDAR system 700 is integrated into a virtual reality (VR) headset. In some other examples, LIDAR system 700 is integrated into an autonomous device, such as a robot or vehicle.

System 700 includes a LIDAR transceiver 701. In exemplary embodiments transceiver 701 comprises one or more PICs. In some embodiments, the one or more PICs are SiPh PICs. Transceiver 701 comprises one or more controllers 710 coupled to control a plurality of concurrent free-space optical beam emissions from a LIDAR transmitter 720, for example according to one or more frequency modulation waveforms 730. The optical beam emissions are at different angles to interrogate a far field target. Controllers 710 are further coupled to a LIDAR receiver 760 operable to collect optical signals from the far field, for example reflected from one or more far field objects 740.

In exemplary embodiments, LIDAR transmitter 720 comprises at least one of the LIDAR Tx architectures 101-601, for example as described elsewhere herein. In some embodiments, LIDAR transmitter 720 is implemented in a single SiPh chip. In other embodiments, LIDAR transmitter 720 is implemented with a plurality of SiPh chips. For example, LIDAR transmitter 720 may comprise a multi-channel source on first SiPh chip and a matrix optical switch on a second SiPh chip.

In some embodiments, LIDAR transmitter 720 and receiver 760 are implemented in a single SiPh chip. In other embodiments, LIDAR transmitter 720 is implemented on one or more first SiPh chips while LIDAR receiver 760 are implemented one or more second SiPh chips. In some embodiments, two or more of controllers 710, LIDAR transmitter 720 and LIDAR receiver 760 are implemented on a single CMOS/SiPh chip. In some advantageous embodiments, all of controllers 710, LIDAR transmitter 720 and LIDAR receiver 760 are implemented on a single CMOS/SiPh chip. For multi-chip embodiments, two or more of the multiple SiPh chips may be co-packaged into a single multi-chip package. In some embodiments, all of controllers 710, LIDAR transmitter 720 and LIDAR receiver 760 are co-packaged into a single multi-chip package.

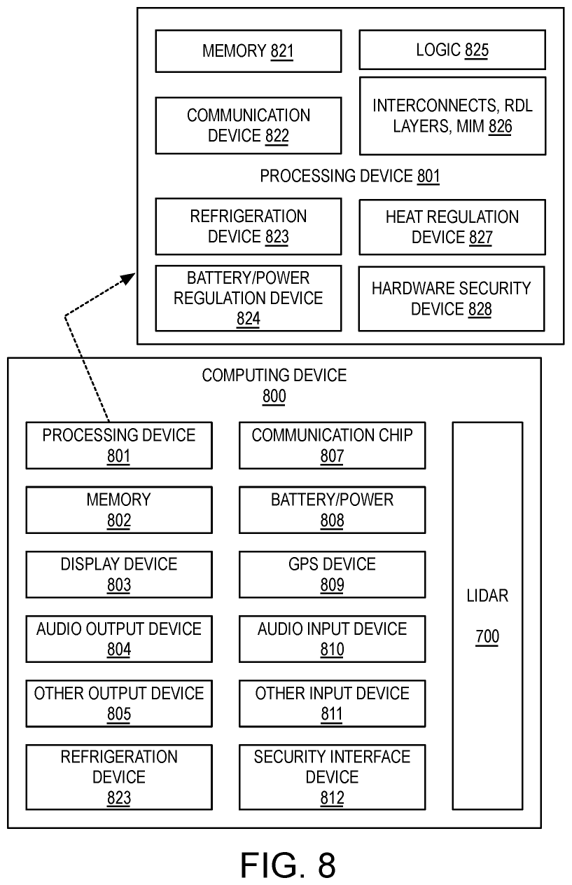

FIG. 8 is a functional block diagram of an electronic computing device 800, that may implement one or more of the components of the LIDAR system 701, in accordance with some embodiments. Computing device 800 may include any of the LIDAR devices or structures discussed elsewhere herein. A number of components are illustrated in FIG. 8 as included in computing device 800, but any one or more of these components may be omitted or duplicated, as suitable for the application. In some embodiments, some of the components included in computing device 800 may be attached to one or more printed circuit boards (e.g., a motherboard). In some embodiments, various ones of these components may be fabricated onto a single system-on-a-chip (SoC) die or implemented with a disintegrated plurality of chiplets or tiles co-packaged together. Additionally, in various embodiments, computing device 800 may not include one or more of the components illustrated in FIG. 8, but computing device 800 may include interface circuitry for coupling to the one or more components. For example, computing device 800 may not include a display device 803, but may include display device interface circuitry (e.g., a connector and driver circuitry) to which display device 803 may be coupled.

Computing device 800 may include a processing device 801 (e.g., one or more processing devices). As used herein, the term processing device or processor indicates a device that processes electronic data from registers and/or memory to transform that electronic data into other electronic data that may be stored in registers and/or memory. Processing device 801 may include a memory 821, a communication device 822, a refrigeration/active cooling device 823, a battery/power regulation device 824, logic 825, interconnects 826, a heat regulation device 827, and a hardware security device 828.

Processing device 801 may include one or more digital signal processors (DSPs), application-specific integrated circuits (ASICs), central processing units (CPUs), graphics processing units (GPUs), or any other suitable processing devices suitable as a LIDAR controller.

Processing device 801 may include a memory 802, which may itself include one or more memory devices such as volatile memory (e.g., dynamic random-access memory (DRAM)), nonvolatile memory (e.g., read-only memory (ROM)), flash memory, solid state memory, and/or a hard drive. In some embodiments, processing 801 shares a package with memory 802. This memory may be used as cache memory and may include embedded dynamic random-access memory (eDRAM) or spin transfer torque magnetic random-access memory (STT-M RAM).

Computing device 800 may include a heat regulation/refrigeration device 823. Heat regulation/refrigeration device 823 may maintain processing device 801 (and/or other components of computing device 800) at a predetermined low temperature during operation. This predetermined low temperature may be any temperature discussed elsewhere herein.

In some embodiments, computing device 800 may include a communication chip 807 (e.g., one or more communication chips). For example, the communication chip 807 may be configured for managing wireless and/or optical communications for the transfer of data to and from computing device 800. The term “wireless” and its derivatives may be used to describe circuits, devices, systems, methods, techniques, communications channels, etc., that may communicate data through the use of modulated electromagnetic radiation through a nonsolid medium. Communication chip 807 may implement any of a number of wireless and/or optical standards or protocols.

Computing device 800 may include LIDAR system 700 to facilitate optical far field interrogation.

Computing device 800 may include battery/power circuitry 808. Battery/power circuitry 808 may include one or more energy storage devices (e.g., batteries or capacitors) and/or circuitry for coupling components of computing device 800 to an energy source separate from computing device 800 (e.g., AC line power).

Computing device 800 may include a display device 803 (or corresponding interface circuitry, as discussed above). Display device 803 may include any visual indicators, such as a heads-up display, a computer monitor, a projector, a touchscreen display, a liquid crystal display (LCD), a light-emitting diode display, or a flat panel display, for example.

Computing device 800 may include an audio output device 804 (or corresponding interface circuitry, as discussed above). Audio output device 804 may include any device that generates an audible indicator, such as speakers, headsets, or earbuds, for example.

Computing device 800 may include an audio input device 810 (or corresponding interface circuitry, as discussed above). Audio input device 810 may include any device that generates a signal representative of a sound, such as microphones, microphone arrays, or digital instruments (e.g., instruments having a musical instrument digital interface (MIDI) output).

Computing device 800 may include a global positioning system (GPS) device 809 (or corresponding interface circuitry, as discussed above). GPS device 809 may be in communication with a satellite-based system and may receive a location of computing device 800.

Computing device 800 may include another output device 805 (or corresponding interface circuitry, as discussed above). Examples include an audio codec, a video codec, a printer, a wired or wireless transmitter for providing information to other devices, or an additional storage device.

Computing device 800 may include another input device 811 (or corresponding interface circuitry, as discussed above). Examples may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 800 may include a security interface device 812. Security interface device 812 may include any device that provides security measures for computing device 800 such as intrusion detection, biometric validation, security encode or decode, managing access lists, malware detection, or spyware detection.

Computing device 800, or a subset of its components, may have any appropriate form factor, such as a hand-held or mobile computing device (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computing device, a server or other networked computing component, a printer, a scanner, a monitor, a set-top box, an entertainment control unit, a vehicle control unit, a digital camera, a digital video recorder, or a wearable computing device.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

In first examples, one or more photonic integrated circuits (PICs), comprising a plurality of light emitters to output a plurality of center wavelengths, a plurality of optical output couplers, and one or more switches optically coupled to the emitters. The switches comprise a plurality of output ports, each of the output ports optically coupled to a subset of the output couplers. The switches are to optically couple each of the emitters to each of the individual output ports in a time divided manner.

In second examples, for any of the first examples the PICs further comprise an optical beam splitter between the output ports and the output couplers.

In third examples, for any of the second examples, the plurality of emitters comprise M emitters, the plurality of output couplers comprise N output couplers, each of the splitters has a 1×N/M splitting ratio, and the switches optically couple each of the M emitters to each of the N output couplers.

In fourth examples, for any of the first through third examples the individual ones of the output ports are optically coupled to the output couplers through an individual one of splitters, wherein an output port each of the splitters is optically coupled to N/M of the output couplers.

In fifth examples, for any of the first through fourth examples the switches comprise one or more of a resonant ring filter, an arrayed waveguide grating (AWG), or an Echelle grating.

In sixth examples, for any of the fifth examples the switches comprise the AWG, the AWG comprises M output waveguides optically coupled to the switch output ports, and the PICs further comprise a phase tuner coupled to the AWG.

In seventh examples, for any of the fifth examples the switches comprise a tunable drop ring waveguide.

In eighth examples, for any of the seventh examples the switches comprise plurality of add ring waveguides coupled to a multi-wavelength bus waveguide that is further coupled to the tunable drop ring waveguide.

In ninth examples, for any of the eighth examples the switches comprise an Echelle grating coupled to the emitters and the tunable drop ring waveguide.

In tenth examples, for any of the first through ninth examples the PICs comprise a semiconductor optical amplifier between each of the output ports and each of the output couplers.

In eleventh examples, for any of the first through the tenth examples the emitters are semiconductor laser emitters, the switch, and the output couplers are on a single chip.

In twelfth examples the semiconductor emitters are continuous wave diode pumping lasers, the plurality of center wavelengths comprise the O-band or C-band of an electromagnetic spectrum, and the output couplers comprise edge coupling spot size converters.

In thirteenth examples, an apparatus comprises a multi-channel light source of a light detection and ranging (LiDAR) transmitter. The light source comprises M light emitters. M is an integer number not less than two and individual ones of the emitters are to output at different wavelengths. The apparatus comprises an array of N optical output couplers. N is an integer number not less than two. The apparatus comprises an optical switch network comprising M input ports optically coupled to the multi-wavelength light source and M output ports optically coupled to the output couplers. Individual ones of the input ports are optically coupled to individual ones of the emitters and individual ones of the output ports are optically coupled to N/M of the output couplers.

In fourteenth examples, for any of the thirteenth examples the switch network is to couple each of the individual input ports to each of the individual output ports in a time divided manner.

In fifteenth examples, for any of the thirteenth through fourteenth examples the individual ones of the output ports are optically coupled to the output couplers through an individual one of M optical beam splitters, wherein an output port each of the beam splitters is optically coupled to N/M of the output couplers.

In sixteenth examples, for any of the fifteenth examples N is an integer multiple of M.

In seventeenth examples, for any of the sixteenth examples N is at least 16 and N/M is at least 2.

In eighteenth examples, a multi-wavelength light detection and ranging (LIDAR) system comprises one or more photonic signal receiving circuits and one or more photonic signal transmission circuits. The photonic signal transmission circuits comprise a plurality of laser emitters coupled through one or more first planar optical waveguides to one or more optical switches. The switches comprises a plurality of output ports that are to be optically couple to each of the laser emitters in a time divided manner. The transmission circuits comprise a plurality of output couplers, each of the output couplers optically coupled through one or more second planar optical waveguides to an individual one of the switch output ports.

In nineteenth examples, for any of the eighteenth examples each of the output couplers are to concurrently output an optical beam generated by a corresponding one of the plurality of laser emitters. The laser emitters are coupled to the optical switches through one or more optical isolators.

In twentieth examples, for any of the nineteenth examples the switch is to modulate which of the output couplers are to output an optical beam generated by individual ones of the laser emitters and light emitted from each of the output couplers is frequency modulated.

It will be recognized that principles of the disclosure are not limited to the embodiments so described, but instead can be practiced with modification and alteration without departing from the scope of the appended claims. The above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

What is claimed is:

1. One or more photonic integrated circuits (PICs), comprising:
a plurality of light emitters to output a plurality of center wavelengths;
a plurality of optical output couplers; and
one or more switches optically coupled to the emitters, wherein the switches comprise a plurality of output ports, each of the output ports optically coupled to a subset of the output couplers, and wherein the switches are to optically couple each of the emitters to each of the output ports in a time divided manner.

2. The PICs of claim 1, further comprising an optical beam splitter between the output ports and the output couplers.

3. The PICs of claim 2, wherein:
the plurality of emitters comprise M emitters;
the plurality of output couplers comprise N output couplers;
each of the splitters has a 1×N/M splitting ratio; and
the switches optically couple each of the M emitters to each of the N output couplers.

4. The PICs of claim 3, wherein individual ones of the output ports are optically coupled to the output couplers through an individual one of M splitters, wherein an output port each of the splitters is optically coupled to N/M of the output couplers.

5. The PICs of claim 1, wherein the switches comprise one or more of a resonant ring filter, an arrayed waveguide grating (AWG), or an Echelle grating.

6. The PICs of claim 5, wherein:
the switches comprise the AWG;
the AWG comprises M output waveguides optically coupled to the output ports; and
the PICs further comprise a phase tuner coupled to the AWG.

7. The PICs of claim 5, wherein the switches comprise a tunable drop ring waveguide.

8. The PICs of claim 7, wherein the switches comprise plurality of add ring waveguides coupled to a multi-wavelength bus waveguide that is further coupled to the tunable drop ring waveguide.

9. The PICs of claim 8, wherein the switches comprise an Echelle grating coupled to the emitters and the tunable drop ring waveguide.

10. The PICs of claim 1, comprising a semiconductor optical amplifier between each of the output ports and each of the output couplers.

11. The PICs of claim 1, wherein the emitters are semiconductor laser emitters, the switch, and the output couplers are on a single chip.

12. The PICs of claim 1, wherein:
the emitters are continuous wave diode pumping lasers;
the plurality of center wavelengths comprise the O-band or C-band of an electromagnetic spectrum; and
the output couplers comprise edge coupling spot size converters.

13. An apparatus comprising:
a multi-wavelength light source of a light detection and ranging (LiDAR) transmitter, the light source comprising M light emitters, wherein M is an integer number not less than two, and wherein individual ones of the emitters are to output at different wavelengths;
an array of N optical output couplers, wherein N is an integer number not less than two; and
an optical switch network comprising M input ports optically coupled to the multi-wavelength light source and M output ports optically coupled to the output couplers, wherein individual ones of the input ports are optically coupled to individual ones of the emitters and individual ones of the output ports are optically coupled to N/M of the output couplers.

14. The apparatus of claim 13, wherein the switch network is to couple each of the individual input ports to each of the individual output ports in a time divided manner.

15. The apparatus of claim 13, wherein the individual ones of the output ports are optically coupled to the output couplers through an individual one of M optical beam splitters, wherein an output port each of the beam splitters is optically coupled to N/M of the output couplers.

16. The apparatus of claim 15, wherein N is an integer multiple of M.

17. The apparatus of claim 16, wherein N is at least 16 and N/M is at least 2.

18. A multi-wavelength light detection and ranging (LIDAR) system, comprising:
one or more photonic signal receiving circuits; and
one or more photonic signal transmission circuits, the photonic signal transmission circuits comprising:
a plurality of laser emitters coupled through one or more first planar optical waveguides to one or more optical switches, wherein the switches comprises a plurality of output ports that are to be optically couple to each of the laser emitters in a time divided manner; and
a plurality of output couplers, each of the output couplers optically coupled through one or more second planar optical waveguides to an individual one of the output ports.

19. The system of claim 18, wherein each of the output couplers are to concurrently output an optical beam generated by a corresponding one of the plurality of laser emitters, and wherein the laser emitters are coupled to the optical switches through one or more optical isolators.

20. The system of claim 19, wherein the switch is to modulate which of the output couplers are to output an optical beam generated by individual ones of the laser emitters, and wherein light emitted from each of the output couplers is frequency modulated.
